(19) United States
(12) Patent Application Publication
(10) Pub. No.: US 2022/0263371 A1
(43) Pub. Date: Aug. 18, 2022

(54) STATOR OF A BRUSHLESS ELECTRIC MOTOR

(71) Applicant: NIDEC Motors & Actuators (Germany) GmbH, Bietigheim-Bissingen (DE)

(72) Inventors: Stanislaw ZBYROWSKI, Zegocina (PL); Jaroslaw RAJCHEL, Wegrzce Wielkie (PL)

(21) Appl. No.: 17/672,739

(22) Filed: Feb. 16, 2022

(30) Foreign Application Priority Data
Feb. 17, 2021 (DE) 102021103722.0

(51) Int. Cl. H02K 3/52; H02K 21/02; H02K 3/28

(52) U.S. Cl. CPC H02K 3/521; H02K 3/28; H02K 21/02

(57) ABSTRACT

A stator includes a rotationally symmetrical stator core with stator teeth which are each at least partially surrounded by an insulator which includes a winding chamber with a winding space bounded on an inner side by an inner flange and on an outer side by an outer flange. Each adjacent pair of the stator teeth define a winding pair, in which a winding wire with a first winding wire end on one side of the winding wire and a second winding wire end on another side of the winding wire is wound around the insulators of the two stator teeth.

### CROSS REFERENCE TO RELATED APPLICATION

The present application claims priority under 35 U.S.C. § 119 to German Application No. 10 2021 103 722.0, filed on Feb. 17, 2021, the entire contents of which are hereby incorporated herein by reference.

### 1. Field of the Invention

The present disclosure relates to a stator of a brushless electric motor, a brushless electric motor, and a method of winding a stator of a brushless electric motor.

### 2. Background

A brushless electric motor as a three-phase electric machine has a stator with a number of, for example, stator teeth arranged in a star shape which carry an electric stator winding wound from an insulating wire. The coils are associated with their coil ends with individual strands and are interconnected with each other in a predetermined manner via common connecting conductors. In the case of a brushless electric motor as a three-phase AC machine, the stator has three strands and thus at least three connecting conductors to which electric current is applied in a phase-shifted manner in each case to generate a rotating magnetic field in which a rotor or armature, usually provided with permanent magnets, rotates. The connecting conductors are led to motor electronics to control the electric motor. The coils of the stator winding are interconnected in a certain way by the connecting conductors. The type of interconnection is determined by the winding scheme of the stator winding, whereby a star connection or a delta connection of the coils is usual as a winding scheme. Provision may be made to wind the stator teeth in pairs in the form of winding pairs. During winding, the stator teeth must make room for the winding tool. Due to this, the wire loses tension at the transition between the stator teeth, which is disadvantageous.

### SUMMARY

Example embodiments of the present disclosure provide stators for brushless electric motors which do not have the above described disadvantages of the prior art, and which each include a tensioned wire between stator teeth of a pair of windings.

A preferred embodiment of the present disclosure provides a stator including a rotationally symmetrical stator core with stator teeth. The stator teeth are each at least partially surrounded by an insulator which includes a winding chamber with a winding space bounded on an inner side by an inner flange and on an outer side by an outer flange. Each two adjacent stator teeth define a winding pair in which a winding wire including a first winding wire end on one side of the winding wire and a second winding wire end on another side of the winding wire is wound around the insulators of the two stator teeth. The outer flange of an insulator of a second stator tooth of each pair of windings includes a lug projecting upward in the axial direction on the upper surface, around which the winding wire is guided and tensioned during the transition from the first stator tooth to the second stator tooth in the winding process.

The winding process can thus be automatic and the winding wire tension can also be maintained in the transition between the stator teeth.

Preferably, all insulators of the stator are identical, even if a nose of the first stator teeth is not used. Costs can be saved by the identical parts approach. However, it can also be provided that only every second insulator includes a projecting nose.

It is advantageous if the lug is located at the end of the upper surface of the outer flange close to the first stator tooth. Preferably, the lug projects in the circumferential direction beyond the winding space of the second stator tooth. It is preferred if the lug adjoins the winding space of the second stator tooth in the circumferential direction.

In an example embodiment of the present disclosure, the first stator tooth of each pair of windings is wound counterclockwise and the second stator tooth is wound clockwise.

The winding pairs are preferably wound in such a way that the winding wire ends each lie on a left side of the respective insulator, in a view outward in the radial direction. This means that the distance between consecutive winding wire ends in the circumferential direction is always identical, which has major advantages for electrical contacting.

Preferably, all pairs of windings of the stator are wound identically.

It is advantageous if the second stator tooth of each pair of windings immediately follows the first stator tooth in a counterclockwise direction.

It is preferable that the outer flange of the insulator includes an elevation on the upper end surface at a distance from the nose, with a space permitting the wire to pass through being provided between the nose and the elevation, which space has a width in the radial direction which is in a range of about 1.1 to about 1.9 multiplied by the diameter of the winding wire. The winding wire is thus guided on both sides, which makes the guidance even more precise.

It can be provided that the outer flange includes a first indentation in the area of the space providing wire guidance, which extends from the inside of the outer flange to the end surface and has a shape corresponding to the winding wire. This first indentation is structured to guide the wire out of the first winding space to the nose.

Preferably, the outer flange includes a second indentation permitting wire guiding which extends from the inside of the outer flange to the end surface and has a shape corresponding to the winding wire, the second indentation being located on a left side of the insulator if seen outward in the radial direction such that a first winding wire end from which the winding originates is guided in the second indentation.

Furthermore, a preferred embodiment of a brushless electric motor includes a rotor, which is mounted rotatably about an axis of rotation, and a stator surrounding the rotor on an outside, the stator being structured as described above.

It is advantageous if the pairs of windings are connected together in a delta circuit.

In addition, an example embodiment of a method of winding a previously described stator is provided, the method including wrapping the first stator tooth of a pair of windings with a first winding direction in the direction from the outer flange to the inner flange and back while maintaining the winding direction, guiding the winding wire from the first stator tooth to the second stator tooth, around the outside of the nose of the outer flange of the insulator of the second stator tooth, and wrapping the second stator tooth with a second winding direction opposite to the first winding direction in the direction from the outer flange to the inner flange and back while maintaining the winding direction.

To create space permitting the winding, adjacent ones of the stator teeth are first aligned approximately parallel, then wound as in the above method, and then folded together and welded as a final step. Since the nose is preferably located near the folding axis, the wire tension is not lost during folding.

It is advantageous if, after winding the first stator tooth, the winding wire is first guided upwards out of the winding space and outwards in the radial direction and then guided along the outside of the nose in the circumferential direction counterclockwise until the winding wire is guided inwards in the radial direction into the winding space of the second stator tooth on the side of the nose facing away from the first stator tooth, and then step c) follows.

The above and other elements, features, steps, characteristics and advantages of the present disclosure will become more apparent from the following detailed description of the example embodiments with reference to the attached drawings.

### BRIEF DESCRIPTION OF THE DRAWINGS

Example embodiments of the present disclosure is explained in more detail below with reference to the drawings. Similar or similarly acting components are designated in the figures with the same reference signs.

FIG. 1 shows a top view of a pair of windings of a stator according to an example embodiment of the present invention.

FIG. 2 shows a spatial view of the outside of the stator of FIG. 1.

FIG. 3 shows a top view of partially wound insulators of the stator of FIG. 1.

FIG. 4 shows a schematic diagram of the winding scheme of the pair of windings according to an example embodiment of the present invention.

### DETAILED DESCRIPTION

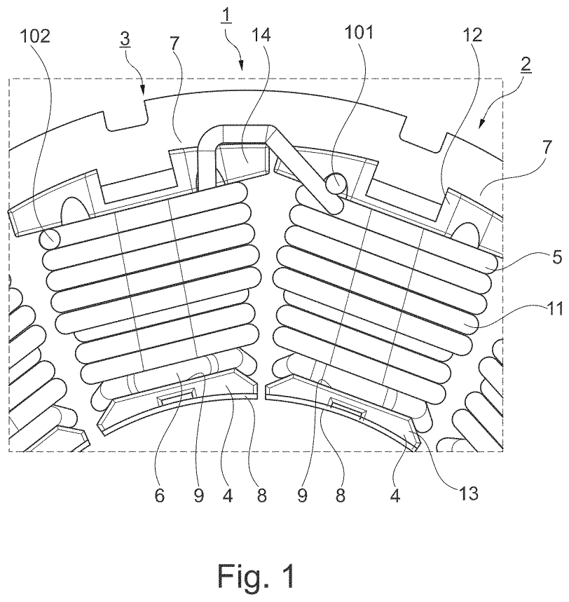

FIG. 1 shows a section of a stator 1 with stator teeth 2,3, to which insulators visible at the end surfaces are assigned. Coils are wound around the stator teeth 2,3 and insulators forming the armature. Two stator teeth 2,3 following each other in the circumferential direction are wound with a winding wire as a winding pair 6. The stator tooth 2 on the right in the illustration is wound first in the radial direction from the outside to the inside and back from the inside to the outside in an anticlockwise direction. Then the winding wire is led to the stator tooth immediately next to it in an anticlockwise direction and this is wound in the opposite direction, in a clockwise direction. All winding pairs of the stator are wound according to the same winding scheme.

Each stator tooth 2,3 has an elongated tooth body, which is not visible, and a tooth root 7 adjoining it at one radial end and a tooth tip 8 adjoining it at the other end. The tooth root 7 is wider than the tooth tip 8 in the circumferential direction relative to the longitudinal axis of the stator and is on the outside in the radial direction. The insulator 4 surrounds the tooth body, at least partially the tooth tip 8, and parts of the tooth root 7. The insulator 4 has in each case a winding chamber 9 around which the winding wire 10 is wound. The winding chamber 9 has a winding space which is bounded in the radial direction to the longitudinal axis of the stator on the inside by an inner flange 11 and on the outside by an outer flange 12.

FIG. 1 shows the top view of the winding pair 6. The first stator tooth 2 is wound counterclockwise, with the first winding wire end of the winding wire 101 located on the left side of the winding chamber 9, radially outward from where the winding takes place. The first stator tooth 2 is wound from the outside to the inside and back from the inside to the outside. Then the winding wire 10 is led to the second stator tooth 3. There, winding takes place in a clockwise direction from the outside to the inside and back from the inside to the outside, with the second winding end 102 also being located on the left side of the winding chamber 9 on the outside in the radial direction. In order to maintain the wire tension present during the winding process at the transition between the stator teeth 2,3, the outer flange of the insulator of the second stator tooth 12 has a lug 14 projecting in the axial direction on the upper side. This lug 14, which may also be referred to as a hook or pin, serves to guide the winding wire during the transition. When viewed from above and looking outward in the radial direction, it is located on the extreme right and joins the winding space on the right in the circumferential direction. In other words, the lug is located at the end of the upper surface of the outer flange 12 near the first stator tooth. After winding the first stator tooth 2, the winding wire 10 is guided out of the winding space 9 upward and outward in the radial direction at an angle of about 45°. Then the winding wire 9 is guided along the outside of the nose 14 in the circumferential direction and around on the side of the nose facing away from the first stator tooth, so that the winding wire 10 is guided inward in the radial direction, into the winding space 9 of the second stator tooth 3 or insulator. Since the nose 14 is closer to the outer diameter of the stator 1, the wire does not lose the desired wire tension when the stator teeth are collapsed after the winding operation. In addition, the position of the wire at the transition between the stator teeth is defined by the guide around the nose.

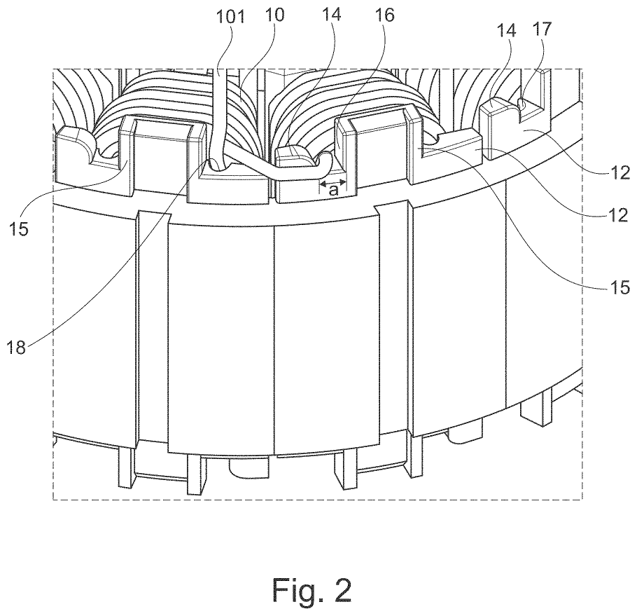

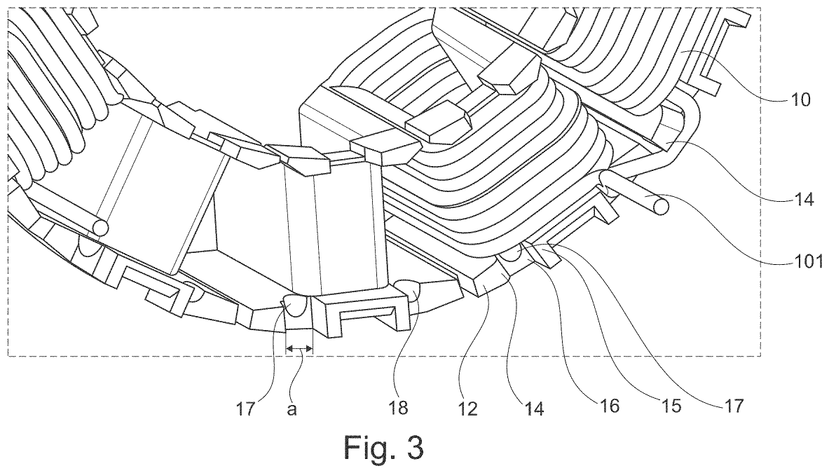

FIGS. 2 and 3 show the wire guide of the winding wire 10 in detail. The outer flange of the insulator 12 has an elevation 15 centrally on its upper side, which projects upwardly beyond the winding and the lug 14. The elevation 15 is u-shaped in cross-section. Whereby the open area faces outward in the radial direction and thus lies on the outside of the outer flange 12. The upper side of the outer flange is arranged at the same height on both sides of the elevation 15, i.e. both sides lie in a common plane. The fact that the areas next to the elevation 15 are much closer to the winding chamber can ensure that the winding wire is guided from the first stator tooth 2 to the second stator tooth 3 along the shortest possible path. Looking outwards in the radial direction, i.e. towards the inside of the outer flange 12, the lug 14 is arranged lying on the outside on the right-hand side of the elevation 15. It thus projects upwards from the common plane of the sides. The space formed between the elevation 15 and the lug for the wire passage 16 has a width in the circumferential direction a which lies in a range between 1.1 and 1.9 multiplied by the wire diameter of the winding wire 10.

In the area between elevation 15 and lug 14, where the wire is passed through, the outer flange 12 has a first indentation 17 on the inside (see in particular FIG. 3). The indentation 17 extends from the inner side of the outer flange to the upper side and has a shape corresponding to the winding wire 10. The first indentation 17 serves as a wire guide after the winding wire has been guided around the lug 14. A second indentation 18 is provided on the other side of the elevation 15. The second indentation 18 also extends from the inside of the outer flange 12 to the top, left side of the elevation 15. The second indentation 18 also has a shape corresponding to the winding wire and serves as a guide for the first winding wire end 101.

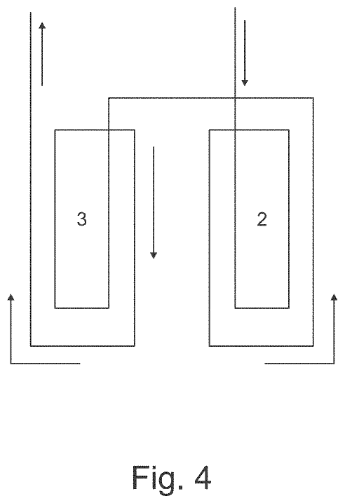

FIG. 4 shows the winding scheme described above. The first stator tooth 2 is wound counterclockwise and the second, closest counterclockwise stator tooth 3 is wound clockwise. All pairs of windings of the stator are wound with this scheme. The stator winding pairs are connected in a delta circuit.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A stator, comprising:
a rotationally symmetrical stator core with stator teeth; and
an insulator including a winding chamber with a winding space which at least partially surrounds the teeth; wherein
the winding space is bounded on an inner side by an inner flange and on an outer side by an outer flange;
each pair of two adjacent ones of the stator teeth include a pair of windings in which a winding wire with a first winding wire end on one side of the winding wire and a second winding wire end on another side of the winding wire are wound around the insulators of the two adjacent ones of the stator teeth;
the outer flange of the insulator of a second stator tooth of each adjacent pair of the stator teeth includes, on an upper side, a lug projecting upwards in an axial direction, around which the winding wire is guided and tensioned in a transition from a first stator tooth of each adjacent pair of the stator teeth to the second stator tooth of each adjacent pair of the stator teeth.

2. The stator according to claim 1, wherein the lug is on the upper side of the outer flange adjacent to the first stator tooth of each adjacent pair of the stator teeth.

3. The stator according to claim 1, wherein the lug projects in a circumferential direction beyond the winding space of the second stator tooth of each adjacent pair of the stator teeth.

4. The stator according to claim 3, wherein the lug is circumferentially adjacent to the winding space of the second stator tooth of each adjacent pair of the stator teeth.

5. The stator according to claim 1, wherein the first stator tooth of each adjacent pair of the stator teeth is wound counterclockwise and the second stator tooth of each adjacent pair of the stator teeth is wound clockwise.

6. The stator according to claim 1, wherein the winding wire ends of the pair of windings are each located on respective left sides of the insulator on each adjacent pair of the stator teeth in plan view and looking outward in a radial direction.

7. The stator according to claim 1, wherein all of the adjacent pairs of the stator teeth are wound identically.

8. The stator according to claim 7, wherein the second stator tooth of each adjacent pair of the stator teeth immediately follows the first stator tooth of each adjacent pair of the stator teeth in a counterclockwise circumferential direction.

9. The stator according to claim 2, wherein
the outer flange of the insulator includes an elevation on the upper side spaced from the lug;
a space permitting wire passage is between the lug and the elevation and has a width in a radial direction which is in a range of about 1.1 to about 1.9 multiplied by a diameter of the winding wire.

10. The stator according to claim 9, wherein the outer flange includes a first indentation in the spacer permitting wire passage, which extends from an inner side of the outer flange to a front side and has a shape corresponding to the winding wire.

11. The stator according to claim 1, wherein
the outer flange includes a second indentation permitting a wire to be guided extending from an inner side of the outer flange to a front side having a shape corresponding to the winding wire; and
the second indentation is located on a left side of the insulator directed outward in a radial direction, such that a first winding wire end from which the winding starts is guided in the second indentation.

12. A brushless electric motor comprising a rotor which is mounted rotatably about an axis of rotation, and the stator according to claim 1 surrounding the rotor externally.

13. The brushless electric motor according to claim 12, wherein the pairs of windings are interconnected in a delta connection.

14. A method of winding a stator of a brushless electric motor, the stator including stator teeth, each of which is at least partially surrounded by an insulator which includes a winding chamber with a winding space bounded on an inner side by an inner flange and on an outer side by an outer flange, each adjacent pair of the stator teeth includes a winding pair, the outer flange of the insulator of a second stator tooth of each pair of two adjacent teeth of the stator teeth includes, on a top end, a lug projecting upwards in an axial direction, the method comprising:
a) wrapping a first stator tooth of each adjacent pair of the stator teeth with a first winding direction in a direction from the outer flange to the inner flange and back while maintaining the first winding direction;
b) guiding the winding wire from the first stator tooth of each adjacent pair of the stator teeth to the second stator tooth of each adjacent pair of the stator teeth, around an outside of a nose of the outer flange of the insulator of the second stator tooth;
c) wrapping the second stator tooth of each adjacent pair of the stator teeth with a second winding direction opposite to the first winding direction in the direction from the outer flange to the inner flange and back while maintaining the second winding direction.

15. The method according to claim 14, wherein, in b), after the winding of the first stator tooth of each adjacent pair of the stator teeth, the winding wire is first guided upwards out of the winding space and outwards in the radial direction and is then guided along the outside of the nose in a circumferential direction counterclockwise, until the winding wire on a side of the lug away from the first stator tooth of each adjacent pair of the stator teeth is guided radially inwards into the winding space of the second stator tooth of each adjacent pair of the stator teeth, and then c) follows.
